(19) United States
(12) Patent Application Publication
(10) Pub. No.: US 2022/0309884 A1
(43) Pub. Date: Sep. 29, 2022

(54) CHECKOUT DEVICE

(71) Applicant: TOSHIBA TEC KABUSHIKI KAISHA, Tokyo (JP)

(72) Inventors: Masaki Ito, Numazu Shizuoka (JP); Yuki Kawaguchi, Tagata Shizuoka (JP); Shinsuke Yajima, Mishima Shizuoka (JP); Toshihiro Kaneko, Izunokuni Shizuoka (JP); Hidehiro Naito, Mishima Shizuoka (JP); Takahiro Saitou, Izunokuni Shizuoka (JP); Taiki Tanihira, Izunokuni Shizuoka (JP); Atsushi Miyashima, Izunokuni Shizuoka (JP)

(21) Appl. No.: 17/552,362

(22) Filed: Dec. 16, 2021

(30) Foreign Application Priority Data
Mar. 23, 2021 (JP) 2021-048876

(51) Int. Cl. G07G 1/00; G07G 5/00; G07D 11/14; G06Q 20/20

(52) U.S. Cl. CPC G07G 1/0018; G07G 1/0045; G07G 5/00; G07D 11/14; G06Q 20/208; G06Q 20/209

(57) ABSTRACT

A checkout device according to an embodiment includes a bill discharge port and a coin discharge port. The bill discharge port is disposed in a left side upper part of a front surface of a housing and discharges bills. The coin discharge port is disposed below the bill discharge port and discharges coins.

### CROSS-REFERENCE TO RELATED APPLICATION

This application is based upon and claims the benefit of priority from Japanese Patent Application No. 2021-048876, filed on Mar. 23, 2021, the entire contents of which are incorporated herein by reference.

### FIELD

Embodiments described herein relate generally to a checkout device, a semi-self checkout device, and a point of sale terminal.

### BACKGROUND

In a retail store such as a supermarket, a checkout device with which a customer himself or herself operates checkout processing has been used. Since the customer operates such a checkout device, further usability has been requested. Therefore, the checkout device needs to enable the customer to intuitively recognize where sections such as a depositing port and a discharge port for money are present.

However, the checkout device of related art has room of improvement.

### DESCRIPTION OF THE DRAWINGS

FIG. 1 is a perspective view illustrating an example of the exterior of a checkout device according to a first embodiment; and

FIG. 2 is a perspective view illustrating an example of the exterior of a self-service POS terminal according to a second embodiment.

### DETAILED DESCRIPTION

An aspect of embodiments is to provide a checkout device that can cause a customer to intuitively recognize disposition.

A checkout device according to an embodiment includes a bill discharge port and a coin discharge port. The bill discharge port is disposed in a left side upper part of a front surface of a housing and discharges bills. The coin discharge port is disposed below the bill discharge port and discharges coins.

Embodiments of a checkout device are explained in detail below with reference to the accompanying drawings. The embodiments explained below are embodiments of the checkout device and do not limit the configuration, the specifications, and the like of the checkout device.

### First Embodiment

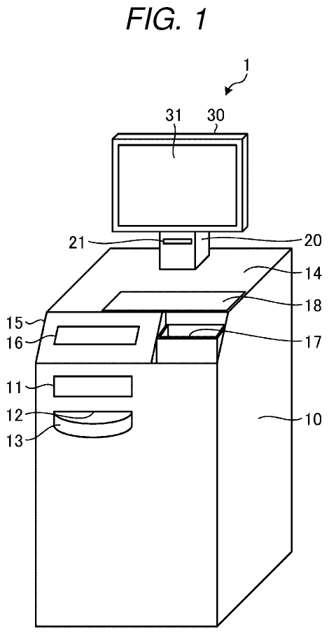

FIG. 1 is a perspective view illustrating an example of the exterior of a checkout device 1 according to a first embodiment. In this embodiment, a direction in which a display surface 31 of a display unit 30 is directed is referred to as front surface side and a direction opposed to the front surface side is referred to as rear surface side.

The checkout device 1 is a device that executes checkout processing for a sales target commodity. For example, the checkout device 1 is used in a semi-self-service checkout system. The semi-self-service checkout system is a system in which a store clerk operates a commodity registration device that registers a sales target commodity and a customer operates the checkout device 1. The checkout device 1 may be a POS terminal with which the customer operates commodity registration processing and checkout processing. In the first embodiment, as an example, the customer operates the checkout device 1. However, a person other than the customer may operate the checkout device 1.

The checkout device 1 includes a first housing 10. The first housing 10 houses a money processing device and the like. The money processing device receives depositing of money such as coins and bills. The money processing device discharges change if there is a difference between a sales price of a commodity or the like and a deposited amount.

The first housing 10 includes a bill discharge port 11. The bill discharge port 11 is disposed in a left side upper part of the front surface of the first housing 10 and discharges bills. The bill discharge port 11 is a discharge port from which bills are discharged by the money processing device.

The first housing 10 includes a coin discharge port 12. The coin discharge port 12 is disposed below the bill discharge port 11 and discharges coins. The coin discharge port 12 is a discharge port from which coins are discharged by the money processing device. The coin discharge port 12 includes a tray 13 that receives the discharged coins. The tray 13 projects to the front surface side. Accordingly, the customer can easily take coins from the tray 13.

Further, since the tray 13 projects to the front surface side, even if the coin discharge port 12 is disposed below the bill discharge port 11, the customer can visually recognize that coins are discharged to the tray 13. Since the bill discharge port 11 and the coin discharge port 12 are disposed in the vicinity, the customer can find the other by finding one.

The first housing 10 includes an inclined surface 15 on the front surface side of an upper surface 14. The inclined surface 15 has inclination lowering from the upper surface 14 to all surfaces.

The first housing 10 includes a coin depositing port 17. The coin depositing port 17 is disposed on the inclined surface 15 provided on the front surface side of the upper surface 14 of the first housing 10 and receives depositing of coins. The coin depositing port 17 has a funnel-like shape. In other words, the coin depositing port 17 is wide in an inlet for receiving coins. The inlet of the coin depositing port 17 is directed upward. Accordingly, the customer can deposit coins by dropping the coins to the coin depositing port 17.

The first housing 10 includes a bill depositing port 16. The bill depositing port 16 is disposed on a side of the coin depositing port 17 on the inclined surface 15 and receives depositing of bills. The bill depositing port 16 is formed substantially perpendicularly to the inclined surface 15. That is, the coin depositing port 17 is directed obliquely upward. Consequently, the customer can deposit bills to the bill depositing port 16 in a state in which the bills are obliquely tilted. Accordingly, the customer can easily deposit the bills to the bill depositing port 16.

The first housing 10 includes a coin placing section 18 in a position in contact with the inclined surface 15 of the upper surface 14 and above the coin depositing port 17. The coin placing section 18 is a region where coins to be deposited to the coin depositing port 17 are temporarily placed. The customer places coins on the coin placing section 18. The customer selects coins to be deposited to the coin depositing port 17 from the coins placed on the coin placing section 18. The customer deposits the selected coins to the coin depositing port 17.

For example, the coin placing section 18 is a tray-shaped recess on which coins are placed. Consequently, the coin placing section 18 suppress the coins from dropping from the inclined surface 15 or scattering on the upper surface 14. The coin placing section 18 is disposed above the coin depositing port 17. Accordingly, the customer can drop the coins selected in the coin placing section 18 to the coin depositing port 17 by slipping and moving the coins. That is, the customer can easily deposit the coins to the coin depositing port 17.

The checkout device 1 includes a second housing 20 on the upper surface 14. The second housing 20 supports the display unit 30 that displays various screens. The display unit 30 is a display device such as a liquid crystal display or an organic EL (Electro Luminescence) display. The display surface 31 of the display unit 30 is directed in a direction in which the coin depositing port 17, the bill depositing port 16, the coin discharge port 12, and the bill discharge port 11 are provided. The display surface 31 is a display portion that displays a screen.

The second housing 20 houses, on the inside, a printing unit that prints a print such as a receipt showing content of checkout by the checkout device 1. The second housing 20 includes, on the front surface side, a receipt discharge port 21 for discharging the print such as the receipt printed by the printing unit. The receipt discharge port 21 is disposed below the display unit 30 on the upper surface 14 of the first housing 10 and discharges the print. The receipt discharge port 21 is an example of a print discharge port.

If the receipt is discharged from the receipt discharge port 21, the customer pulls the receipt to take the receipt. Therefore, a space for enabling the customer to pull the receipt is necessary between the customer and the receipt discharge port 21. Therefore, the receipt discharge port 21 is disposed on the rear surface side of the upper surface 14 of the first housing 10. Consequently, in the checkout device 1, the space for enabling the customer to pull the receipt is formed. Accordingly, the customer can easily take the receipt. Since the receipt discharge port 21 is disposed below the display unit 30, the receipt discharge port 21 is easily found by the customer.

As explained above, the checkout device 1 according to this embodiment includes the first housing 10. The bill discharge port 11 is disposed in the left side upper part of the front surface of the first housing 10. The coin discharge port 12 is disposed below the bill discharge port 11. Since the bill discharge port 11 is disposed on the front surface of the first housing 10 and the coin discharge port 12 is disposed below the bill discharge port 11, an operator can find the discharge ports without looking for the discharge ports. Accordingly, the checkout device 1 can cause the operator such as the customer to intuitively recognize disposition.

### Second Embodiment

In the first embodiment, as an example, the first embodiment is applied to the checkout device 1 of the semi-self-service checkout system. In a second embodiment, as an example, the second embodiment is applied to a self-service POS (Point of Sales) terminal 2 with which a customer operates commodity registration processing for registering a sales target commodity and checkout processing. The same components as the components in the first embodiment are denoted by the same reference numerals and signs and explanation of the components is omitted.

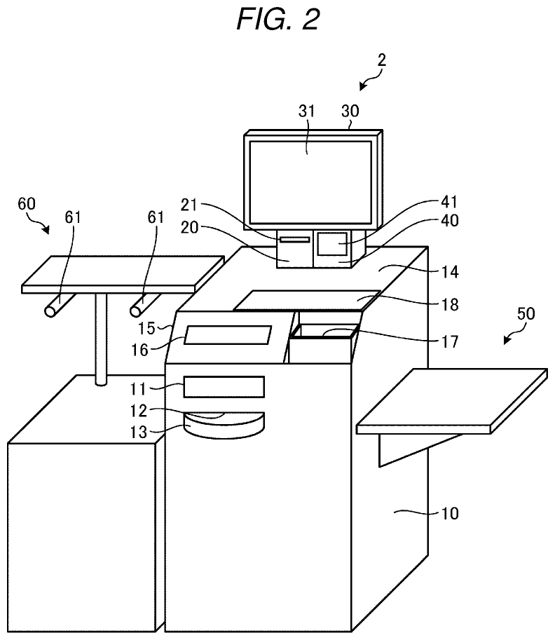

FIG. 2 is a perspective view illustrating an example of the exterior of the self-service POS terminal 2 according to the second embodiment. The self-service POS terminal 2 includes substantially the same configuration as the configuration of the checkout device 1. That is, the self-service POS terminal 2 includes the first housing 10, the second housing 20, and the display unit 30 that are the same as those of the checkout device 1. The self-service POS terminal 2 includes a third housing 40, a basket placing table 50, and a bagging table 60 in addition to the sections of the checkout device 1.

The third housing 40 is disposed on a side of the second housing 20 on the upper surface 14 of the first housing 10. The third housing 40 houses a scanner on the inside. The third housing 40 includes, on the front surface side, a reading window 41 that transmits light. The third housing 40 may be disposed in another position without being limited to the side of the second housing 20. Further, the self-service POS terminal 2 may include a housing that incorporates a printer and a scanner.

The scanner reads, via the reading window 41, a code symbol such as a barcode attached to a commodity held above the front of the reading window 41. The scanner decodes the code symbol to thereby acquire a commodity code for identifying the commodity.

The basket placing table 50 is a table on which a basket or the like storing commodities before commodity registration is placed. The basket placing table 50 is disposed on the right side of the first housing 10.

The bagging table 60 is a table for putting the commodities after the commodity registration in a bag or the like of a customer. The bagging table 60 is disposed on the left side of the first housing 10. The bagging table 60 includes supporting bars 61 that catch and support the bag. The supporting bars 61 support the bag in an open state. Accordingly, the customer can easily put the commodities in the bag.

The basket placing table 50 and the bagging table 60 may include scales that measure weight. An operator takes a commodity put in the basket on the basket placing table 50. The operator performs commodity registration by holding a code symbol of the commodity over the reading window 41 and causing the scanner to read a commodity code. The operator puts the commodity, for which the commodity registration is performed, in the bag on the bagging table 60. In this series of processes, by acquiring the weight of the commodity specified by the read commodity code from a server device or the like, the self-service POS terminal 2 can determine propriety of whether the commodity registration is appropriately performed.

As explained above, the self-service POS terminal 2 according to the second embodiment includes the first housing 10 having the same form as the form of the checkout device 1. That is, the bill discharge port 11 is disposed in the left side upper part of the front surface of the first housing 10. The coin discharge port 12 is disposed below the bill discharge port 11. In this way, the bill discharge port 11 is disposed on the front surface of the first housing 10 and the coin discharge port 12 is disposed below the bill discharge port 11. Therefore, the operator can find the discharge ports without looking for the discharge ports. Accordingly, the self-service POS terminal 2 can cause the operator such as the customer to intuitively recognize disposition.

Several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A checkout device, comprising:
a bill discharge port disposed in a left side upper part of a front surface of a housing and configured to discharge bills; and
a coin discharge port disposed below the bill discharge port and configured to discharge coins.

2. The checkout device according to claim 1, further comprising a print discharge port disposed below a display on an upper surface of the housing and configured to discharge a print.

3. The checkout device according to claim 2, wherein the print discharge port is disposed on a rear surface side of the upper surface of the housing.

4. The checkout device according to claim 1, further comprising a coin depositing port disposed on an inclined surface provided on a front surface side of an upper surface of the housing and configured to receive depositing of coins.

5. The checkout device according to claim 4, further comprising a bill depositing port disposed on a side of the coin depositing port on the inclined surface and configured to receive depositing of bills.

6. The checkout device according to claim 2, wherein the print discharge port is configured to discharge a receipt.

7. The checkout device according to claim 1, further comprising a coin placing recess in the upper surface.

8. A semi-self checkout device, comprising:
a bill discharge port disposed in a left side upper part of a front surface of a housing and configured to discharge bills;
a coin discharge port disposed below the bill discharge port and configured to discharge coins; and
a scanner configured to read a commodity code symbol.

9. The semi-self checkout device according to claim 8, further comprising a print discharge port disposed below a display on an upper surface of the housing and configured to discharge a print.

10. The semi-self checkout device according to claim 9, wherein the print discharge port is disposed on a rear surface side of the upper surface of the housing.

11. The semi-self checkout device according to claim 8, further comprising a coin depositing port disposed on an inclined surface provided on a front surface side of an upper surface of the housing and configured to receive depositing of coins.

12. The semi-self checkout device according to claim 11, further comprising a bill depositing port disposed on a side of the coin depositing port on the inclined surface and configured to receive depositing of bills.

13. The semi-self checkout device according to claim 9, wherein the print discharge port is configured to discharge a receipt.

14. A point of sale terminal, comprising:
a bill discharge port disposed in a left side upper part of a front surface of a housing and configured to discharge bills;
a coin discharge port disposed below the bill discharge port and configured to discharge coins;
a commodity registration table; and
a scanner configured to read a commodity code symbol.

15. The point of sale terminal according to claim 14, further comprising a print discharge port disposed below a display on an upper surface of the housing and configured to discharge a print.

16. The point of sale terminal according to claim 15, wherein the print discharge port is disposed on a rear surface side of the upper surface of the housing.

17. The point of sale terminal according to claim 14, further comprising a coin depositing port disposed on an inclined surface provided on a front surface side of an upper surface of the housing and configured to receive depositing of coins.

18. The point of sale terminal according to claim 17, further comprising a bill depositing port disposed on a side of the coin depositing port on the inclined surface and configured to receive depositing of bills.

19. The point of sale terminal according to claim 15, wherein the print discharge port is configured to discharge a receipt.

20. The point of sale terminal according to claim 14, further comprising a coin placing recess in the upper surface.
